(19) United States
(12) Patent Application Publication
(10) Pub. No.: US 2026/0301389 A1
(43) Pub. Date: Oct. 1, 2026

(54) METHOD AND ELECTRONIC DEVICE WITH KERNEL COMBINATION DETERMINATION

(71) Applicants: Samsung Electronics Co., Ltd., Suwon-si (KR); POSTECH Research and Business Development Foundation, Pohang-si (KR)

(72) Inventors: Jung-Mok LEE, Pohang-si (KR); Hyeon-Woo NAM, Pohang-si (KR); Ye-Bin MOON, Pohang-si (KR); Tae-Hyun OH, Pohang-si (KR)

(73) Assignees: Samsung Electronics Co., Ltd., Suwon-si (KR); POSTECH Research and Business Development Foundation, Pohang-si (KR)

(21) Appl. No.: 19/445,297

(22) Filed: Jan. 9, 2026

(30) Foreign Application Priority Data
Mar. 27, 2025 (KR) 10-2025-0039522

(51) Int. Cl. G06V 10/776; G06V 10/70; G06V 10/762; G06V 10/82; G06V 10/84

(52) U.S. Cl. CPC G06V 10/776; G06V 10/7635; G06V 10/768; G06V 10/82; G06V 10/84; G06V 10/87

(57) ABSTRACT

A processor-implemented method includes determining one or more kernel combinations corresponding to time-series data based on information output by inputting the time-series data, information on a predetermined kernel combination, and first prompt information into a first visual language model (VLM), determining an optimized parameter set from one or more parameter sets, for each of the one or more kernel combinations, inputting second prompt information into a second VLM to analyze one or more graphs corresponding to the optimized parameter set, for each of the one or more kernel combinations, determining one or more scores for each of the one or more kernel combinations based on an output generated by the inputting of the second prompt information into the second VLM, and determining, in response to the one or more scores being determined, a recommended kernel combination from the one or more kernel combinations based on the one or more scores.

### CROSS-REFERENCE TO RELATED APPLICATIONS

This application claims the benefit of Korean Patent Application No. 10-2025-0039522, filed on Mar. 27, 2025 in the Korean Intellectual Property Office, the entire disclosure of which is incorporated herein by reference for all purposes.

### BACKGROUND

### 1. Field

The following description relates to a method and electronic device with a kernel combination determination.

### 2. Description of the Related Art

Time-series data may refer to data collected continuously over a period of time. This data may be used in various fields such as finance, medicine, manufacturing, and weather forecasting. To analyze the data, an effective method for modeling the visual patterns of the data may be used. One such method for analyzing time-series data is by using the kernel-based machine learning technique.

Kernel methods may convert data into a high-dimensional space so that patterns in non-linear data can be learned. This technique may be used in various models, such as support vector machines (SVMs) and Gaussian process (GP) regressions. The Gaussian process regression may be used for forecasting time-series data, as it may enable the quantification of uncertainties in the data.

The performance of the model may be greatly affected by the choice of the kernel function used for the time-series data. Among kernel functions used for time-series data are the linear (LIN), radial basis function (RBF), and periodic (PER) kernels, and an appropriate kernel may be selected based on the characteristics of the time-series data.

Typical methods for exploring kernel combinations mainly involved manually selecting specific kernels and determining kernel combinations through experiments based on those selections. However, the typical method requires a significant amount of operations when combining kernels and determining the optimal combination, leading to increased computational costs. Additionally, the typical method is more complex and inefficient in finding the optimal combination, as the manual selection of kernels inevitably relies on the experience of the individual performing the task. Additionally, manually selected kernel combinations are highly prone to overfitting the dataset, which may deteriorate generalization performance of the model for new data.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one or more general aspects, a processor-implemented method includes determining one or more kernel combinations corresponding to time-series data based on information output by inputting the time-series data, information on a predetermined kernel combination, and first prompt information into a first visual language model (VLM), determining an optimized parameter set from one or more parameter sets, for each of the one or more kernel combinations, inputting second prompt information into a second VLM to analyze one or more graphs corresponding to the optimized parameter set, for each of the one or more kernel combinations, determining one or more scores for each of the one or more kernel combinations based on an output generated by the inputting of the second prompt information into the second VLM, and determining, in response to the one or more scores being determined, a recommended kernel combination from the one or more kernel combinations based on the one or more scores.

The determining of the one or more kernel combinations may include determining whether analytical information output by the first VLM, based on the time-series data, the information on the predetermined kernel combination, and the first prompt information, is included in a model space in which the first VLM is able to learn about the predetermined kernel combination based on the time-series data, and determining the one or more kernel combinations based on the analytical information in response to the analytical information being determined to be included in the model space.

The determining of whether the analytical information is included in the model space may include determining first context information based on the time-series data, the information on the predetermined kernel combination, and the first prompt information, and, based on the analytical information output by inputting the first context information into the first VLM, performing a process comprising updating, in response to the analytical information being included in a language space, the first context information based on the analytical information, updating, in response to the analytical information being included in a code space, the first context information based on observation information which is obtained by executing code generated based on the analytical information, and determining, in response to the analytical information being included in the model space, the one or more kernel combinations based on the analytical information.

The performing of the process may include determining whether a length of second context information, generated by updating the first context information, is less than a predetermined maximum context length, and repeating the process based on the second context information, in response to the length of the second context being less than the predetermined maximum context length.

The method may include determining a plurality of initial parameter sets for each of the one or more kernel combinations using a genetic algorithm, wherein determining the optimized parameter set includes determining the optimized parameter set through likelihood-based optimization of the plurality of initial parameter sets.

The one or more graphs may include a first graph plotted based on the time-series data, and one or more second graphs plotted based on the one or more kernel combinations and the optimized parameter set.

The determining of the one or more scores may include determining a difference between a value obtained by multiplying information output by the second VLM by a weight, and a Bayesian information criterion (BIC) for the one or more kernel combinations and the time-series data, as the one or more scores.

The second prompt information may include an instruction to evaluate similarity between the first graph and each of the one or more second graphs in a first interval containing the time-series data, and structure similarity of the one or more second graphs between the first interval and a second interval during which the time-series data is not present.

The method may include removing a kernel combination from the one or more kernel combinations through cross-validation, that does not satisfy a predetermined condition related to an extrapolation test in an interval during which the time-series data is not present.

The determining of the optimized parameter set further may include removing one or more parameter sets from the one or more parameter sets for each of the one or more kernel combinations.

The determining of the recommended kernel combination may include determining a predetermined number of kernel combinations from the one or more kernel combinations as the recommended kernel combination, based on descending order of the one or more scores.

The method may include determining a predictive data distribution in an interval during which the time-series data is not present, based on the determined recommended kernel combination, and visually outputting either one or both of the predictive data distribution and summarized information of the predictive data distribution.

In one or more general aspects an electronic device includes one or more processors comprising processing circuitry, and memory comprising one or more storage media storing instructions that, when executed individually or collectively by the one or more processors, cause the electronic device to determine one or more kernel combinations corresponding to time-series data based on information output by inputting the time-series data, information on a predetermined kernel combination, and first prompt information into a first visual language model (VLM), determine an optimized parameter set from one or more parameter sets, for each of the one or more kernel combinations, input one or more graphs corresponding to the optimized parameter set into a second VLM, for each of the one or more kernel combinations, determine one or more scores for each of the one or more kernel combinations based on an output generated by the inputting of the one or more graphs into the second VLM, and determine, in response to the one or more scores being determined, a recommended kernel combination from the one or more kernel combinations based on the one or more scores, by executing the instruction.

For the determining of the one or more kernel combinations, the execution of the instructions may cause the electronic device to determine whether analytical information output by the first VLM, based on the time-series data, the information on the predetermined kernel combination, and the first prompt information, is included in a model space in which the first VLM is able to learn about the predetermined kernel combination based on the time-series data, and determine the one or more kernel combinations based on the analytical information in response to the analytical information being determined to be included in the model space.

For the determining of whether the analytical information is included in the model space, the execution of the instructions may cause the electronic device to determine first context information based on the time-series data, the information on the predetermined kernel combination, and the first prompt information and based on the analytical information output by inputting the first context information into the first VLM, perform a process comprising updating, in response to the analytical information being included in a language space, the first context information based on the analytical information, updating, in response to the analytical information being included in a code space, the first context information based on observation information which is obtained by executing code generated based on the analytical information, and determining, in response to the analytical information being included in the model space, the one or more kernel combinations based on the analytical information

For the performing of the process, the execution of the instructions may cause the electronic device to determine whether a length of second context information, generated by updating the first context information, is less than a predetermined maximum context length, and repeat the process based on the second context information, in response to the length of the second context being less than the predetermined maximum context length.

The one or more graphs may include a first graph plotted based on the time-series data, and one or more second graph plotted based on the one or more kernels combination and the optimized parameter set.

For the determining of the one or more scores, the execution of the instructions may cause the electronic device to determine a difference between a value obtained by multiplying information output by the second VLM by a weight, and a Bayesian information criterion (BIC) for the one or more kernel combinations and the time-series data, as the one or more scores.

The second prompt information may include an instruction to evaluate similarity between the first graph and each of the one or more second graphs in a first interval containing time-series data, and structural similarity of the one or more second graphs between the first interval and a second interval during which the time-series data is not present.

In one or more general aspects, a processor-implemented method includes determining context information based on time-series data, information on a predetermined kernel combination, and first prompt information, determining analytical information by inputting the context information to a first visual language model (VLM), in response to a length of the context information being less than a predetermined maximum context length, updating the context information based on either one or both of the analytical information and observation information, depending on whether the analytical information is included a language space or a code space, and determining one or more kernel combinations corresponding to the time-series data based on the updated the context information.

Other features and aspects will be apparent from the following detailed description, the drawings, and the claims.

### BRIEF DESCRIPTION OF THE FIGURES

FIG. 1 illustrates an overall process of the method according to one or more embodiments.

FIG. 2 is a flowchart illustrating a method according to one or more embodiments.

FIG. 3 is a flowchart illustrating a process of a first visual language model recommending a kernel combination by analyzing time-series data, according to one or more embodiments of a method.

FIG. 4 is a flowchart illustrating a process of recommending a kernel combination based on whether analytical information output by a first visual language model is included in a language space, code space, and/or model space, according to one or more embodiments of a method.

FIG. 5 illustrates input and output data of a first visual language model according to one or more embodiments.

FIG. 6 illustrates graphs of time-series data and kernel combinations that may be output by a first visual language model through an analyze-execute process, along with corresponding processing steps.

FIG. 7 is a diagram illustrating how a pool of kernel combinations and a cluster of parameters of each kernel combination are managed, according to one or more embodiments.

FIG. 8 is a diagram illustrating a process in which a second visual language model determines a score based on a kernel combination and an optimized parameter set, using the optimized parameter set for each kernel combination included in a pool of kernel combinations, according to one or more embodiments.

FIG. 9 is a diagram illustrating a process of outputting a recommended kernel combination among a plurality of kernel combinations, based on a score output by a second language model according to one or more embodiments.

FIG. 10 is a block diagram illustrating an electronic device, according to one or more embodiments.

FIG. 11 is a block diagram illustrating an electronic system including a computing device, according to one or more embodiments.

Throughout the drawings and the detailed description, unless otherwise described or provided, the same drawing reference numerals may be understood to refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of the disclosure of this application may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application. The use of the term “may” herein with respect to an example or embodiment (e.g., as to what an example or embodiment may include or implement) means that at least one example or embodiment exists where such a feature is included or implemented, while all examples are not limited thereto. The use of the terms “example”, “embodiment”, and “example embodiment” herein have a same meaning (e.g., the phrasing ‘in an or one example’ has a same meaning as ‘in an or one embodiment” and ‘in an or one example embodiment’), and “one or more examples” has a same meaning as “one or more embodiments” and “one or more example embodiments”. Still further, each of multiple or all separately described an/one “example”, “embodiment”, “example embodiment”, as well as “examples”, “embodiments”, “example embodiments”, herein may be included, in combination, in a same embodiment in any combination.

Throughout the specification, when a component or element is described as being “on”, “connected to,” “coupled to,” or “joined to” another component, element, or layer it may be directly (e.g., in contact with the other component, element, or layer) “on”, “connected to,” “coupled to,” or “joined to” the other component, element, or layer or there may reasonably be one or more other components, elements, layers intervening therebetween. When a component, element, or layer is described as being “directly on”, “directly connected to,” “directly coupled to,” or “directly joined” to another component, element, or layer there can be no other components, elements, or layers intervening therebetween. Likewise, expressions, for example, “between” and “immediately between” and “adjacent to” and “immediately adjacent to” may also be construed as described in the foregoing.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” specify the presence of stated features, numbers, operations, members, elements, and/or combinations thereof, other embodiments may exist where one or more of the stated features, numbers, operations, members, elements, and/or combinations thereof are not present.

Unless otherwise defined, all terms, including technical and scientific terms, used herein have the same meaning as commonly understood by one of ordinary skill in the art to which this disclosure pertains and specifically in the context on an understanding of the disclosure of the present application. Terms, such as those defined in commonly used dictionaries, are to be interpreted as having a meaning that is consistent with their meaning in the context of the relevant art and specifically in the context of the disclosure of the present application, and are not to be interpreted in an idealized or overly formal sense unless expressly so defined herein.

As used herein, the term “and/or” includes any one and any combination of any two or more of the associated listed items. The phrases “at least one of A, B, and C”, “at least one of A, B, or C”, and the like are intended to have disjunctive meanings, and these phrases “at least one of A, B, and C”, “at least one of A, B, or C” (e.g., each phrase may include any one of the respective items alone, all of the items listed together, and all possible combinations thereof), and the like also include examples where there may be one or more of each of A, B, and/or C (e.g., any combination of one or more of each of A, B, and C), unless the corresponding description and embodiment necessitates such listings (e.g., “at least one of A, B, and C”) to be interpreted to have a conjunctive meaning.

In the following description, example embodiments of the present disclosure will be described in detail with reference to accompanying drawings so that those skilled in the art can easily carry out the present disclosure. The present disclosure may be applied in many different forms and is not limited to the embodiments described herein.

Hereinafter, example embodiments of the present disclosure will be described with reference to the drawings.

Although direct intervention of a domain expert may be used for time-series data analysis during a process of identifying and interpreting characteristics of time-series data, such an approach may require high human resources and may increase analysis time, which may make it difficult to efficiently process large volumes of time-series data.

A typical technique for automating data analysis, known as the Greedy Tree Search method for exploring kernel combinations and parameters, may quickly identify an optimal solution within a specific structure but does not sufficiently consider the overall search space. Additionally, since the typical method does not explore function combinations during actual data analysis, it may not accurately dynamically identify an optimal analysis model suited to the characteristics of the data.

Furthermore, while large language models (LLMs) may analyze and forecast time-series data, these models lack the ability to utilize data representations such as graph visualizations and analytical features.

In contrast, a method and electronic device of one or more embodiments may automatically explore an optimal kernel combination and parameters, accurately dynamically identify an optimal analysis model suited to the characteristics of the data, and utilize data representations such as graph visualizations and analytical features.

According to example embodiments, a method and electronic device of one or more embodiments may provide automated kernel combination suggestions through time-series data analysis using a visual-language model. The method and electronic device of one or more embodiments may enable visual analysis and evaluation of characteristics of the time-series data, thereby enhancing accuracy and efficiency of data analysis beyond what is achievable through simple exploration of kernel combinations and parameters. According to example embodiments, the method and electronic device of one or more embodiments may provide a new automated framework which allows for exploring and analyzing complicated patterns of data while minimizing intervention of domain experts.

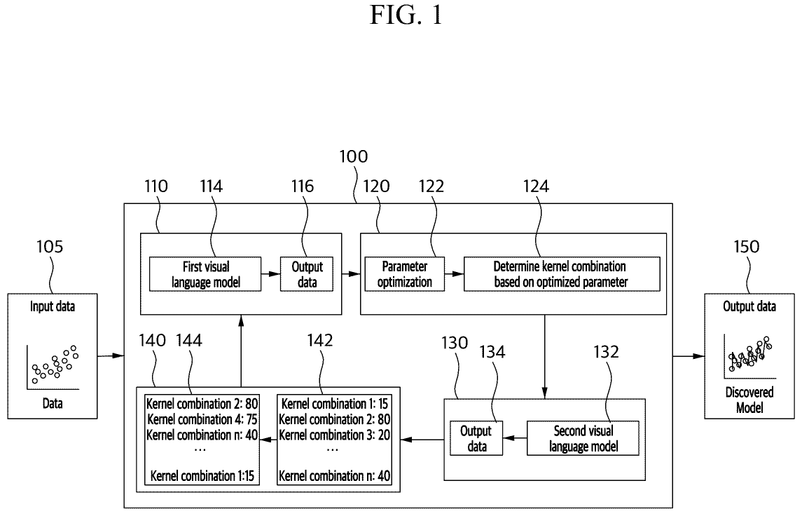

FIG. 1 illustrates an overall process of the method according to one or more embodiments.

Referring to FIG. 1, an electronic device 100 may obtain and analyze time-series data 105 and determine output data 150 corresponding to the result of the analysis. Here, the output data 150 may include a recommended kernel combination corresponding to the time-series data 105 included in input data.

According to one or more embodiments, the electronic device 100 may perform a first process 110 in which at least one kernel combination is determined by analyzing the time-series data 105, a second process 120 in which an optimized parameter set is fitted to each of the at least one kernel combination determined in the first process 110, a third process 130 in which a score for each kernel combination is generated as output data by inputting the kernel combinations and their corresponding optimized parameter sets fitted, into a second visual language model, and a fourth process 140 in which a recommended kernel combination is determined based on the scores of each of the at least one kernel combination. The electronic device 100 may update information on the at least one kernel combination in the first process, using information on the recommended kernel combination determined in the fourth process. For example, the series of processes from the first process 110 to the fourth process 140 may be recursively (e.g., iteratively) repeated, and the number of repetitions may correspond to a predetermined threshold number of rounds R.

Hereinafter, detailed descriptions of example embodiments of the first to fourth processes 110 to 140 performed by the electronic device 100 will be provided.

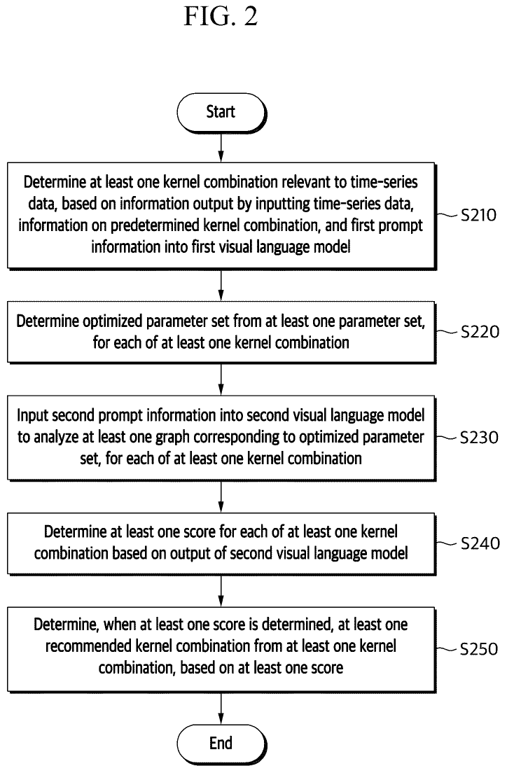

FIG. 2 is a flowchart illustrating a method according to one or more embodiments. The operations of FIG. 2 may be performed in the sequence and manner as illustrated in FIG. 2. However, one or more of the operations may be performed in a different order, one or more of the operations may be omitted, two or more of the operations may be performed in parallel or simultaneously, and/or other operations may be additionally performed without departing from the spirit and scope of the described embodiments.

In operation S210, the electronic device 100 may determine at least one kernel combination relevant (e.g., corresponding) to time-series data, based on information output by inputting the time-series data, information on a predetermined kernel combination, and first prompt information into a first visual language model. In an example, operation S210 may correspond to the first process 110 of FIG. 1.

According to one or more embodiments, the time-series data may refer to data collected sequentially over a period of time. Such data may be utilized in various fields and for different purposes, such as finance, medicine, weather forecasting, industrial process monitoring, and energy consumption analysis. Time-series data may be highly time-dependent, with each data point strongly associated with the preceding one, rather than existing independently. To effectively analyze the time-series data, the data may be modeled by considering its essential characteristics. For example, stock prices may be influenced by previous prices, and temperature data may be closely related to past temperatures. To reflect these characteristics, an auto-regressive model or kernel-based Gaussian process may be used to model time-series data more effectively.

Additionally, time-series data may exhibit long-term pattern changes, such as a rise in stock prices due to economic growth or an increase in average temperature due to global warming. The electronic device 100 may use a kernel, such as radial basis function (RBF) kernel or linear kernel, to accurately model such trends, allowing gradual changes in the data to be reflected more effectively.

Time-series data may exhibit seasonal patterns that repeat in specific cycles, such as daily, weekly, monthly, or yearly intervals. For instance, time-series data that shows changes in power consumption across seasons and increased retail revenues at the end of the year may be considered as exhibiting seasonality. The electronic device 100 may apply a periodic kernel to time-series data exhibiting seasonality to more effectively model the recurring patterns therein.

Time-series data may exhibit autocorrelation, where a data point has high correlation with an adjacent data point. For example, a case where the temperature of one day is closely related to the temperature of the following day corresponds to this. The electronic device 100 may model changes over a time interval using a method such as Matern kernel to reflect characteristics of such time-series data.

Time-series data may be univariate or multivariate, where different types of variables, such as sensor data and economic indicators, interact with each other. For example, when analyzing weather data, various variables such as temperature, humidity, and atmospheric pressure may be considered. In such cases, the time-series data may be multivariate. To effectively analyze multivariate time-series data, the electronic device 100 may use a technique such as matrix kernel or multiple kernel learning, to perform modeling through an analysis reflecting correlations between variables.

Apart from these characteristics, time-series data may also be highly likely to contain noise due to factors such as sensor errors, data collection problems, and unexpected events. For example, a particular value may rise or fall suddenly due to a sensor error. To address such issues, the electronic device 100 may apply a robust kernel technique or a probabilistic modeling technique that includes noise modeling, to detect outliers and ensure stability.

According to one or more embodiments, the electronic device 100 may use time-series data 105, a threshold number of rounds R, and information on a kernel combination P as initial data for the first process 110. The electronic device 100 may input first prompt information to a first visual language model 114 as input data. Information to be input to the first visual language model 114 may include the time-series data 105, the threshold number of rounds R, and the information on the predetermined kernel combination P, along with the first prompt information that serves as an instruction for processing the input data. The first prompt information may include default data which is predetermined by the electronic device 100, the obtained time-series data 105, and/or data input by a user through an input interface of the electronic device 100.

According to one or more embodiments, when the first process 110 is conducted for the first time, the information on the predetermined kernel combination P may include information on base kernels forming various kernel combinations (e.g., linear kernels, periodic kernels, and squared exponential (SE) kernels), information on a combination of the base kernels, and/or constant C and white noise WN, and the like, as initial information of the kernel combination.

The electronic device 100 may determine first context information using the first prompt information, the time-series data 105, and the information on the predetermined kernel combination, prior to performing the first process 110 using the first visual language model 114. The information on the predetermined kernel combination used to determine the first context information may include information on the at least one kernel combination determined through the first process 110 to fourth process 140. For example, the electronic device 100 may use the at least one kernel combination determined in the fourth process 140 based on an output (e.g., output data 134) of a second visual language model 132 in the round immediately preceding the round in which the first process 110 is performed (for example, in round n−1, when an nth number of round is to be performed). When the first process 110 to the fourth process 140 have not been performed in the preceding round, the electronic device 100 may perform the first process 110 by determining initial context information, determined based on the time-series data 105, the first prompt information, and the information on the base kernels, as the first context information. Then, the first context information may be updated as a second context information based on analytical information output by the first visual language model 114. The context information may be updated repeatedly as the first visual language model analyzes the time-series data 105, with updates continuing as long as the length of the updated context information is less than a predetermined maximum context length (Nₘₐₓ). A detailed description of an example of a context analysis process performed by the first visual language model 114 will be provided hereinafter.

Output data 116 output by the first visual language model 114 may include information on the at least one kernel combination corresponding to the time-series data 105.

In operation S220 the electronic device 100 may determine an optimized parameter set, among at least one parameter set, for each of the at least one kernel combination. In an example, operation S220 of determining an optimized parameter set may correspond to the second process 120 of FIG. 1.

The electronic device 100 may determine an optimized parameter set for each kernel combination, based on at least one parameter set corresponding to each of the at least one kernel combination output as a result of the first process 110. The electronic device 100 may perform population-based optimization to optimize parameters for each kernel combination using the base kernels in operation 122. The electronic device 100 may determine the most optimized parameter suited for the time-series data 105 within a parameter cluster for each kernel combination managed through population-based optimization. The population-based optimization may include an algorithm such as a genetic algorithm, and may allow exploration of the entire search space, unlike greedy search.

For example, when the electronic device 100 optimizes a parameter for a kernel combination composed of RBF, periodic and Matern kernels, parameters such as length scale, periodicity, and smoothness (v) of each kernel may be initialized as multiple candidate sets. Then, a parent parameter set to be forwarded to the next generation may be selected by evaluating fitness of the initialized parameter sets and selecting a parameter set with high fitness value. An optimal solution may be gradually achieved by retaining such parameter sets with high fitness values for the next generation. Additionally, various explorations may be carried out through variation processes such as crossover and mutation. The electronic device 100 may determine a parameter set, that is ultimately selected in response to repeating the optimization process up to a threshold number of iterations, as the optimized parameter set for the kernel combination. The electronic device 100 of one or more embodiments may manage and optimize parameter sets using a clustering technique, which is for managing a number of parameter sets for each kernel combination, and may achieve both efficiency and exploration diversity by merging parameters that have been optimized individually within each cluster. In addition, the electronic device 100 of one or more embodiments may avoid local optimization by managing parameters of kernel combinations using a population-based optimization technique, such as a genetic algorithm.

The electronic device 100 may determine fitness based on likelihood of each parameter set. For example, the electronic device 100 may determine an optimized parameter set through likelihood-based optimization of each initial parameter set. For example, the electronic device 100 may determine a parameter set that maximizes the likelihood of p(D|θ, M). as the optimized parameter set. Here, D may denote the time-series data 105, and θ may denote each parameter set, and M may denote each kernel combination.

The electronic device 100 may determine a kernel combination in operation 124 based on the optimized parameter set determined through optimization of parameters for each kernel combination in operation 122, and the second process 120 may be performed on each kernel combination determined in the first process 110.

In operation S230, the electronic device 100 may input second prompt information into the second visual language model 132 for each kernel combination to analyze at least one graph corresponding to the optimized parameter set, based on a result of the second process. In an example, operation S230 may correspond to a part of the third process 130 of FIG. 1.

Referring to FIG. 1, with respect to the electronic device 100, the information input to the second visual language model 132 may also include the time-series data 105, information on the at least one kernel combination determined in the first process 110, and information on the optimized parameter set for each kernel combination determined in the second process 120. The second prompt information input to the second visual language model 132 may include an instruction to determine whether at least one second graph, plotted based on the at least one kernel combination determined in the first process 110 and the optimized parameter set for each of the at least one kernel combination determined in the second process 120, aligns with the first graph corresponding to the time-series data 105. For example, the second prompt information may include an instruction to evaluate similarity between the first graph in a first interval containing the time-series data 105 and each of the at least one second graph, and structure similarity of the at least one second graph between the first interval and a second interval during which the time-series data 105 is not present. For example, the second visual language model 132 may include an instruction to determine a degree of similarity between a second graph, which is plotted using the at least one kernel combination determined in the first process 110 and the optimized parameter set for each kernel combination determined in the second process 120, and a first graph corresponding to the time-series data 105, determine structural similarity between the first interval and the second interval during which the time-series data 105 is not present, and taking into account a confidence area.

In operation S240, the electronic device 100 may determine at least one score for each kernel combination based on output data 134 of the second visual language model 132. The electronic device 100 may output a score indicating the degree of similarity between the first graph and the at least one second graph, based on the second prompt information input to the second visual language model in operation S230, as the output score 134. The score relevant to each kernel combination and optimized parameter set may be determined using Equation 1 below, for example.

$$VSC = α \cdot EvaluatorVLM ( ℳ , {θ}^{*} , 𝒟 ) - BIC \qquad Equation 1$$

Here [symbol] may denote the at least one kernel combination determined in the first process 110, θ* may denote the optimized parameter set for each kernel combination determined in the second process 120, D may denote the time-series data 105, BIC may denote Bayesian information criterion, α may denote a hyper parameter, and VSC may denote a visual selection criterion. EvaluatorVLM ( [symbol] , θ*, [symbol] )) includes fitness and structure similarity scores of the second graph as information produced by the second visual language model using the at least one kernel combination, the optimized parameter set, and the time-series data 105. The fitness of the second graph may indicate the extent to which the kernel combination follows the trend of the time-series data 105, and the structure similarity may indicate the consistency of the trend in training and non-training areas of the kernel combination.

The fitness score may refer to a value that quantifies the degree of similarity between the first graph, which represents the time-series data 105, and the second graph, which corresponds to a mean prediction graph plotted based on the kernel combination. The electronic device 100 may use the second visual language model 132 to visualize 95% of the confidence area of the mean prediction generated by the kernel combination. When an uncertainty area is large or increases suddenly in a non-training data area, a low fitness score may be determined in EvaluatorVLM ( [symbol] , θ*, [symbol] ).

The structure similarity score refers to a value that quantifies the overall structure similarity of the second graph between training data area and non-training data area. The electronic device 100 may determine a posterior mean and a confidence area in both training data area and non-training data area to measure structure similarity, and may use the second visual language model 132 to visualize the results. The second visual language model 132 may determine, through visualization, whether the forecast generated by the kernel combination in the non-training data area is well generalized. That is, when the second graph exhibits a structurally inconsistent trend while transitioning from the training data area to the non-training data area, the second visual language model 132 may compute a low structural similarity score.

The fitness and structure similarity may be measured repeatedly, and they may converge due to stochastic nature of the second visual language model. The second visual language model may determine the value of EvaluatorVLM ( [symbol] , θ*, [symbol] ) by adding up the fitness and structure similarity scores.

The electronic device 100 may take Equation 2 below, for example, into consideration to determine a value of Bayesian information criteria, based on the kernel combination and optimized parameter set.

$$BIC = - 2 log p ( 𝒟 \vert ℳ , {θ}^{*} ) + k log n \qquad Equation 2$$

Here, [symbol] may denote the at least one kernel combination determined in the first process 110, θ* may denote the optimized parameter set for each kernel combination determined in the second process 120, D may denote the time-series data 105, K may denote the number of parameters of a kernel combination, and n may denote a sample size of the time-series data.

In operation S250, when at least one score is determined in operation S240, the electronic device 100 may determine at least one recommended kernel combination from the at least one kernel combination based on the at least one score. In an example, operation S250 may correspond to the fourth process 140 of FIG. 1.

Referring to FIG. 1, a score output by the second visual language model 132 may be assigned to each of the at least one kernel combination determined in the first process 110. Referring to a kernel combination pool 142, each kernel combination may be assigned with different scores. The electronic device 100 may sort the kernel combinations included in the kernel combination pool 142 based on the scores, select a predetermined number of kernel combinations in descending order of score, and determine at least one recommended kernel. For example, when the predetermined number of kernel combinations is 1, the kernel combination 2 may be determined as the recommended kernel combination in the sorted kernel combination pool 144. Alternatively, when the predetermined number of kernel combinations is 3, the kernel combinations 2, 4, and n may be determined as the recommended kernel combinations in the sorted kernel combination pool 144. However, the predetermined number of kernel combinations is not limited to the examples provided above. In an example, the electronic device 100 may determine a predetermined number of kernel combinations assigned with the greatest scores among the different score as the recommended kernel combinations. In another example, the electronic device 100 may determine kernel combinations assigned with the scores greater than or equal a predetermined value as the recommended kernel combinations.

As described above, the first process 110 through fourth process 140 may be repeated by the predetermined number of rounds R. Upon completion of the fourth process 140, the electronic device 100 may include the at least one kernel combination determined in the first process 110 in information on the kernel combination P. Therefore, when the number of repetitions of the first process 110 through the fourth process 140 has not reached the threshold number of rounds R, the at least one kernel combination determined in the first process 110 may be used as the information on the kernel combination P for the next round of the first process 110.

When the number of repetitions of the first process 110 through the fourth process 140 has reached the threshold number of rounds R in operation S250, the electronic device 100 may generate and provide output data 150 to a user, indicating that the at least one recommended kernel combination determined in operation S250 is an appropriate kernel combination corresponding to the time-series data 105.

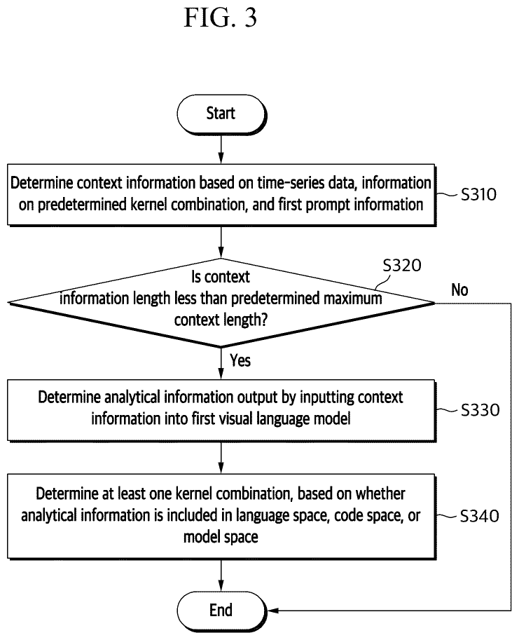

FIG. 3 is a flowchart illustrating a process of the first visual language model 114 recommending a kernel combination by analyzing the time-series data 105, according to one or more embodiments of a method. FIG. 3 is a flowchart illustrating an example of the first process 110, describing in detail how data is input and output via the first visual language model 114 used by the electronic device 100. The operations of FIG. 3 may be performed in the sequence and manner as illustrated in FIG. 3. However, one or more of the operations may be performed in a different order, one or more of the operations may be omitted, two or more of the operations may be performed in parallel or simultaneously, and/or other operations may be additionally performed without departing from the spirit and scope of the described embodiments.

In operation S310, the electronic device 100 may determine context information based on time-series data, information on a predetermined kernel combination, and first prompt information. The context information determined in operation S310 may be initial context information to be updated in the following processes.

In operation S320, the electronic device 100 may determine whether a length of the context information is less than a predetermined maximum context length. The electronic device 100 may determine the length of the context information based on the amount of given visual data and text information. The electronic device 100 may determine the context length of text information included in the context information input to the first visual language model 114 in tokens, and for visual data such as a graph, the context length may be determined by considering factors such as visual complexity. For multimodal input that includes various types of data, such as text information, visual data, and code, the electronic device 100 may determine the context length based on the aforementioned factors. However, the criteria for determining the context length are not limited to the described example embodiments and may also be determined using various conventional techniques for processing the context of data input to artificial intellectual models and determining the context length.

In operation S330, when the length of the context information determined in operation S310 is less than the predetermined maximum context length, the electronic device 100 may determine analytical information output by inputting the context information to the first visual language model.

When the length of the context information determined in operation S310 is less than the predetermined maximum context length, the electronic device 100 may output a message requesting a revision of least one of the time-series data, predetermined kernel combination information, and first prompt information, as the first visual language model is unable to determine analytical information based on the context information determined in operation S310. When the shortened length of the context information is less than the predetermined maximum context length, the electronic device 100 may perform the first process 110 again based on the context information with shortened length. When the length of the context information determined in operation S310 is greater than the predetermined maximum context length, the electronic device 100 may perform the first process 110 again. Alternatively, in response to the first process 110 being initiated, manual intervention of a user in the first process 110 through the fourth process 140 may be reduced.

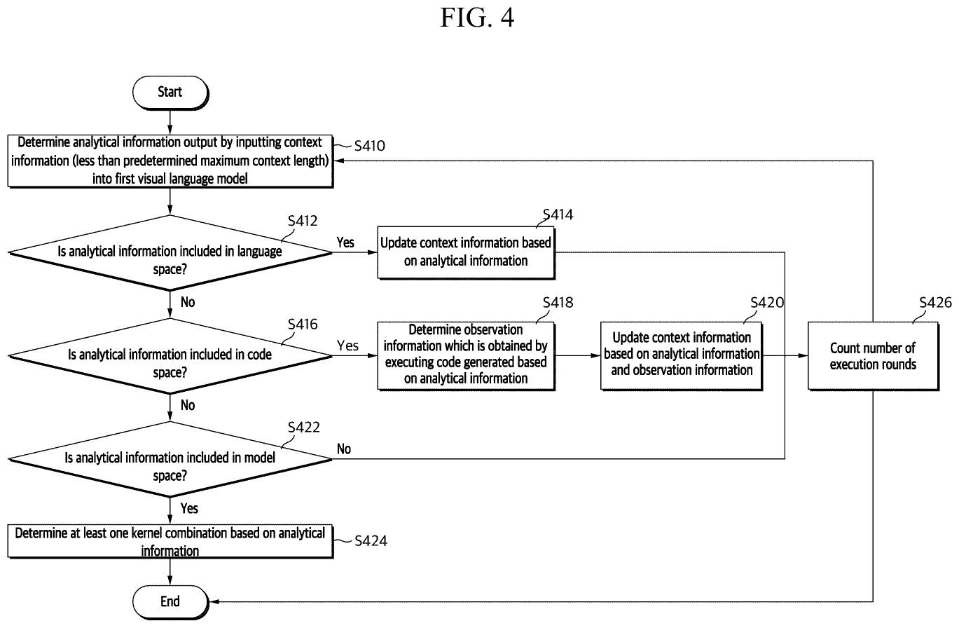

In operation S340, the electronic device 100 may determine at least one kernel combination based on whether the analytical information is included in a language space, code space, and/or model space. Hereinafter, a detailed description of examples of characteristics of operation S340 will be provided with reference to FIG. 4.

FIG. 4 is a flowchart illustrating a process of recommending a kernel combination based on whether analytical information output by a first visual language model is included in a language space, code space, and/or model space, according to one or more embodiments of a method. The operations of FIG. 4 may be performed in the sequence and manner as illustrated in FIG. 4. However, one or more of the operations may be performed in a different order, one or more of the operations may be omitted, two or more of the operations may be performed in parallel or simultaneously, and/or other operations may be additionally performed without departing from the spirit and scope of the described embodiments.

In operation S410, when a length of first context information determined based on time-series data, information on a predetermined kernel combination, and first prompt information is less than a predetermined maximum context length, the electronic device 100 may determine analytical information output by inputting the first context information to the first visual language model 114. Hereinafter, for illustrative purposes, a description will be provided under an assumption that the first context information refers to the context information before an update, and the second context information refers to the context information determined by updating the first context information.

The electronic device 100 may determine whether the analytical information output by the first visual language model is included in the model space in which the first visual language model 114 is able to learn about the predetermined kernel combination based on the time-series data.

In operation S412, the electronic device 100 may determine whether the analytical information is included in the language space.

The language space may refer to a space where the first visual language model 114 analyzes, describes, and infers based on natural language. When generating analytical information in a form of natural language based on data input to the first visual language model 114, the analytical information may include descriptions, pattern analysis, summaries, and inferences about the input data as information included in the language space. For example, when time-series data and/or a graph corresponding to the time-series data is included in data input to the first visual language model 114, the first visual language model 114 may output analytical information that interprets and describes the data, such as: “The time-series data (or graph) exhibits a trend of increasing product prices since 2025, with seasonal fluctuations”. The language space provides information in a form easily understood by humans and such information is important for supporting data-driven decision-making.

In operation S414, when the analytical information is included in the language space, the electronic device 100 may update the first context information using the analytical information included in the language space. When an output of the first visual language model 114 is included in the language space, the process of updating the context information based on the output may involve optimizing the context by providing feedback on the analysis results, summaries, and interpretations of the text generated by the first visual language model 114. For example, when a user requests, ‘Check for trends over specific time intervals in the time-series data.’ in response to the first visual language model 114 analyzing the graph, the first visual language model 114 may generate and provide a response such as, ‘Sudden increases in March and July 2025 have been identified in the time-series data.’. The user may then request the model to ‘Analyze the reasons for these increases.’, and the electronic device 100 may generate more refined context information based on the previous analysis.

In operation S416, when the analytical information is not included in the language space, the electronic device 100 may determine whether the analytical information is included in the code space.

The code space may refer to a space where the first visual language model 114 converts natural language input into a code format. The first visual language model 114 may generate programming code for analyzing or visualizing the time-series data in the code space. The language used to generate the programming code may include Python, structured query language (SQL), and/or R. For example, when an instruction such as “Generate a code to visualize the data” is included in the first prompt information input to the first visual language model 114, the first visual language model 114 may output code to generate a graph by analyzing the input time-series data, using applications such as Matplotlib or NumPy. When the output of the first visual language model 114 includes analytical information that instructs the model to generate code for analyzing the time-series data, it may be understood that the model converts the analysis results of the input time-series data into programming code (e.g., Python or SQL) and provides the code to the user for execution. This may indicate that the first visual language model 114 is configured to determine more advanced statistical analysis code for data analysis by itself, given that the model provides code (base) for calling and executing an external module required. Therefore, this may provide a point of difference compared to simply exploring data and outputting a natural language description. In operation S418, when the analytical information is included in the code space, the electronic device 100 may execute the code generated based on the analytical information included in the code space, and determine observation information according to the result of the code execution. The observation information obtained by executing the code output by the first visual language model 114 may include values, logs, graphs, and model performance indicators generated in response to the code execution. The observation information may also include errors, warnings, and debugging logs generated during the code execution.

In operation S420, the electronic device 100 may update the first context information based on the observation information determined in operation S418. The electronic device 100 may form a repetitive feedback loop for updating the context and continuously generate updated output by analyzing and reflecting on the observation information resulting from the code generated by the first visual language model 114. The first visual language model 114 may perform code editing, performance optimization, and data conversion, for example, based on the observation information. The process of updating the context may involve several steps, such as collecting observation information from the executed code, updating and reflecting on the context, and generating new output. When there is an error in the executed code or when the similarity between a kernel combination and the time-series data 105 is low (e.g., less than or equal to a predetermined threshold), the model may output revised code with the error addressed and/or recommend a more appropriate kernel combination.

In operation S422, when the analytical information is not included in the code space, the electronic device 100 may determine whether the analytical information is included in the model space.

The model space may refer to a space where the first visual language model 114 configures a machine learning model or determines the optimal kernel combination. Within the model space, various machine learning and mathematical modeling including analysis of the time-series data 150 may take place, and an appropriate kernel combination may be determined by analyzing characteristics of the time-series data 105. For example, when the first visual language model 114 detects a trend and seasonality from the time-series data 105, the model may recommend an appropriate model such as “Gaussian process regression (GPR) or seasonal autoregressive integrated moving average (SARIMA) model corresponds to the time-series data, and the optimal kernel combination is RBF and periodic kernels.”

When the first context information is updated in operation S414 or S420, and/or when the analytical information is determined not to be included in the model space in operation S422, the electronic device 100 may count the number of times the first context information included in the first process 110 has been updated in operation S426. In operation S426, the electronic device 100 may recursively perform operation S410, using the second context information determined by counting the number of executions and updating the first context information. The counting of the number of executions is performed solely for the recursive process and may be selectively omitted when operations S410 through S422 can be performed recursively using alternative methods that do not require counting the number of executions.

In operation S424, when the analytical information is included in the model space, the electronic device 100 may determine at least one kernel combination based on the analytical information. A detailed description on the at least one kernel combination will be omitted as it may correspond to the output data 116 of the first visual language model described above.

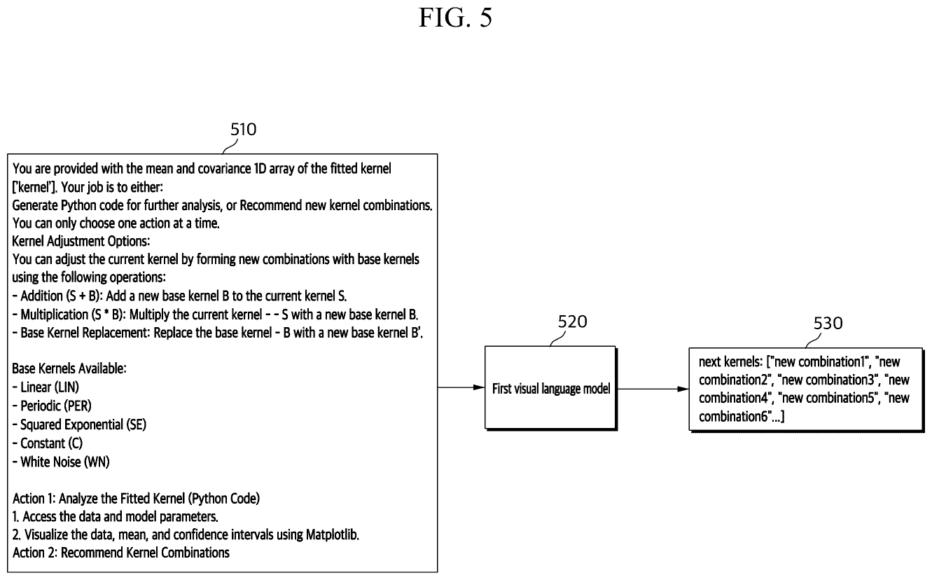

FIG. 5 illustrates input and output data of a first visual language model 520 according to one or more embodiments.

FIG. 5 includes first prompt information 510, as an example, according to one or more embodiments. Referring to FIG. 5, the first prompt information 510 may include an instruction to perform a process based on mean and covariance information of each kernel. For example, the first prompt information 510 may include an instruction to generate code for analyzing a kernel combination subject for analysis at a given time (e.g., Action 1 of FIG. 5) and recommend a new kernel combination (e.g., Action 2 of FIG. 5) to improve performance of the first visual language model 520 that determines kernel combinations. The first prompt information 510 may include an instruction to plot a second graph based on mean and covariance values of a kernel combination (e.g., by using Matplotlib) by executing the code for analyzing a kernel combination, and to mark a confidence area to the second graph. When the second graph, including the mean value and confidence area forecasted by the first visual language model 520 to which the first prompt information 510 was input, is output, the electronic device 100 of one or more embodiments may allow a user to intuitively determine how well the kernel combination reflects the patterns of the time-series data 105, thereby reducing the user's workload.

The first prompt information 510 may include a kernel tuning method for recommending a new kernel combination. For example, the tuning of a kernel combination may be specified via the first prompt information 510, allowing it to be carried out through addition, multiplication, and/or replacement. Adding a new kernel to an existing kernel combination allows for better reflection of complex data patterns, multiplying kernels is useful for modeling correlation effects, and replacing some of base kernels included in an existing kernel combination with another base kernel may result in more appropriate kernel combination.

For example, when the existing kernel combination includes only squared exponential (SE) kernels, modifying it to a combination such as SE+periodic (PER) form enables the kernel combination to reflect the periodicity present in time-series data 105. Alternatively, when the SE kernel is overfitted, the SE kernel may be replaced with a linear kernel to better model the linear patterns in the time-series data 105. Through the process, the first visual language model 520 may output at least one kernel combination to be used in the current round of execution as output data 530. As described above, information on the kernel combination included in the output data 530 may be used in the second process 120.

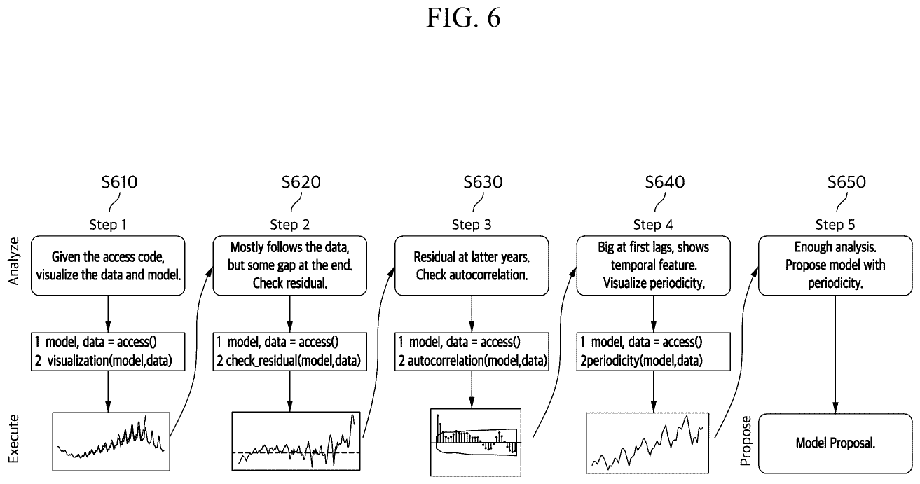

FIG. 6 illustrates graphs of time-series data 105 and kernel combinations that may be generated as an output of an analyze-execute process of the first language model 114, along with corresponding processing steps.

Referring to FIG. 6, the first visual language model 114 may determine and output visual data with different characteristics, by repeating the analyze-execute process. When first prompt information is input to the first visual language model 114 of the electronic device 100, the first visual language model 114 may visualize and output visualization, residual, autocorrelation, and periodic information of the kernel combination and the time-series data 105.

In operation S610, the first visual language model 114 may visualize a kernel combination and time-series data 105 based on first prompt information. For example, in operation S610, the first visual language model 114 may determine how accurately the mean, covariance, and confidence area aligns with the time-series data 105. The first visual language model 114 may output a first graph representing the time-series data 105 and a second graph generated by the kernel combination, along with visual information on the mean, covariance, and confidence area. For example, when the confidence area of the second graph is wide, it may indicate a high level of uncertainty.

In operation S620, the first visual language model 114 may analyze a residual based on information output in operation S610 based on the first prompt information. The first visual language model 114 may output a residual graph based on residuals of data corresponding to the first and second graphs determined in operation S610. Through residual analysis, the electronic device 100 of one or more embodiments may enable the first visual language model 114 to identify a pattern in the time-series data 105 that was not captured by the kernel combination currently performing the analysis.

The first visual language model 114 may determine that a particular area (e.g., at least a portion of a training area and/or non-training area) exhibits a high number of errors by performing the residual analysis according to the first prompt information. For example, when the residual determined in operation S620 according to the first prompt information exhibits a particular pattern, the first visual language model 114 may determine that the kernel combination currently performing the analysis is not configured to fully analyze the time-series data 105, and may determine whether modification of the current kernel combination is to be performed, in consideration of normality of residual distribution.

When a residual distribution, caused by a difference between the time-series data 105 and data forecasted by the kernel combination (and/or between the first and second graphs), exhibits an increasing trend over time, the first visual language model 114 may determine that forecast uncertainty is rising, due to the kernel combination's inability to fully capture the variability in the time-series data 105. For example, when the kernel combination currently performing the analysis is based on LIN+SE*(PER+C)), where LIN stands for a linear kernel, SE for a squared exponential kernel, PER for a periodic kernel, and C for a constant term, the residual dispersion may increase due to the model being too simple or not flexible enough to capture the data's complexity, and/or the constant term may be unnecessary.

In operation S630, the first visual language model 114 may analyze autocorrelation between residuals according to the first prompt information. The residual analysis may show that the time-series data 105 and the kernel combination currently performing the analysis do not align over time. This could indicate a time-dependency between the residuals, and that the kernel combination is unable to capture this, despite having a certain level of meaningfulness. According to the kernel combination currently performing the analysis, the kernel combination may be evaluated by considering the type of lag distribution the result of the residual analysis exhibits in operation S640. For example, when a value of autocorrelation is high at a point where a lag is closer to 0 and lags after that show low values of autocorrelation, it may indicate that the autocorrelation is present while the residual between the time-series data 105 and the kernel combination is short, but may be independent in long-term. The first visual language model 114 may output a graph visualizing a result of an autocorrelation analysis.

Apart from the described example embodiments, the first visual language model 114 may determine whether the time-series data 105 aligns with the kernel combination by considering various types of data (e.g., mean and dispersion) indicated by the residual.

The first visual language model 114 may determine observation information based on the result of the residual analysis described above. Based on the autocorrelation analysis of the residuals, the visual language model 114 may determine that additional analysis is required to explore trends in the time-series data 105, such as determining a cycle of a periodic component, and perform the additional analysis to determine a new kernel combination. For example, the first visual language model 114 may determine that the current kernel combination needs to be modified, based on several observations: (i) the mean value forecasted using the current kernel combination (LIN+SE*(PER+C)) shows a significant deviation near the end of the time series, suggesting that the kernel combination is not effectively capturing the trends in the time-series data 105, (ii) the residuals exhibit high autocorrelation, indicating that the forecasts of the current kernel combination may not be independent and that the current covariance structure of the kernel combination may be poorly suited to the data, potentially leading to increased uncertainty, and (iii) although the current kernel combination is able to capture both linear and periodic trends, the inclusion of the constant term C and squared exponential SE may be unnecessary, as the kernel may be too simple or inflexible to describe the full complexity of the data, as the dispersion of the residuals increases.

The first visual language model 114 may use a Fourier transform graph to determine base kernels and their combination for modifying the current kernel structure, based on frequency components present in the time-series data 105, magnitude of the frequencies, and data related to the frequencies. For example, the first visual language model 114 may determine at least one kernel combination as a new kernel combination, based on the analysis result of the current kernel combination (LIN+SE*(PER+C)), such as PER*(LIN+SE), PER+(LIN*SE), PER*SE+LIN, LIN+PER*C, SE*PER+C, and PER*(LIN+C).

In operation S650, the first visual language model 114 may propose a kernel combination with an improved structure and better alignment of the time-series data 105, based on the analysis described above. The proposal may be included in the output data 116 of FIG. 1.

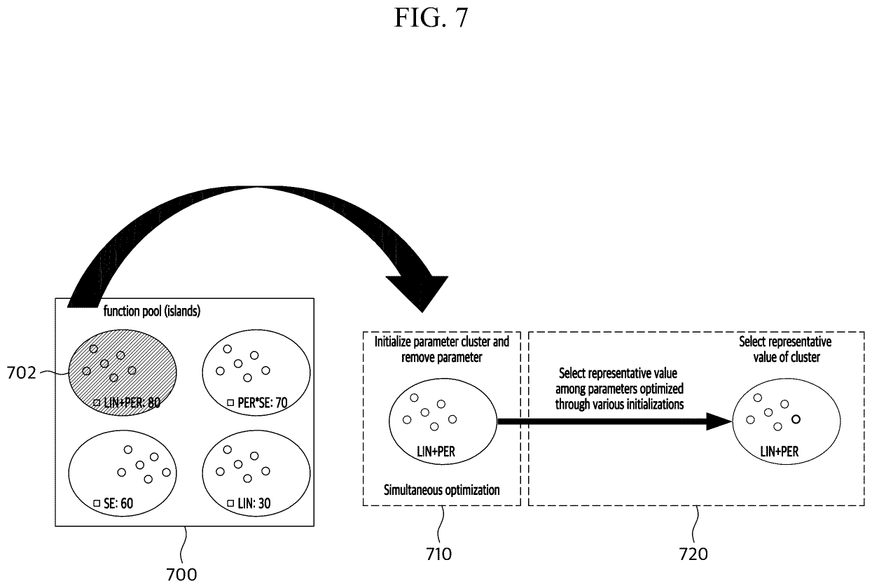

FIG. 7 is a diagram illustrating how a pool of kernel combinations and a cluster of parameters of each kernel combination are managed, according to one or more embodiments.

The electronic device 100 may generate at least one parameter set 700 for each of at least one kernel combination included in the output data 116 generated by the first visual language model 114. An initial parameter set included in the at least one parameter set 700 may have been determined for each kernel combination when generating the at least one kernel combination based on the analysis result of the time-series data 105 by the first visual language model 114. The electronic device 100 may manage each of the at least one parameter set as a cluster. That is, the parameter set of each kernel combination may form a cluster including a combination of various parameters, and the electronic device 100 may select one of these parameter sets included in a cluster as an optimized parameter set, which best aligns the kernel combination with the time-series data 105 based on the analysis result of the time-series data 105.

When a kernel combination is determined in the first process 110, based on at least one parameter set 700 for each of at least one kernel combination generated by repeating the first process 110 through the fourth process 140, the electronic device 100 may determine an optimized parameter set 702 in the second process 120, based on the kernel combination. For example, when the current kernel combination is LIN*PER, the at least one parameter set of the kernel combination may include,

$${σ}_{LIN}^{2}$$

(a scaling parameter for the linear kernel), c (offset of the linear kernel),

$${σ}_{PER}^{2}$$

(a scaling parameter of the periodic kernel), [symbol] (a length parameter of the periodic parameter), and p (a periodic parameter of the periodic kernel). The electronic device 100 may generate and manage a cluster in operation 710 formed of individual parameters of parameter sets determined in the second process 120, and determine one of the parameter sets as an optimized parameter set in operation 720. Each of the at least one parameter set 700 may include an optimized parameter set which is determined based on the results of the first process 110 through the fourth process 140.

The electronic device 100 may train and utilize an optimization model to optimize each parameter set simultaneously, which was performed individually for each of the at least one parameter set in the second process 120. In response to generating the at least one parameter set, the parameter sets may be managed by removing a parameter set that does not meet a predetermined condition. In response to generating an initial parameter set for the current kernel combination and determining an optimized parameter set through the optimization process, the electronic device 100 may remove all parameter sets except the optimized parameter set. Through this, a parameter set that shows low forecast performance in both the training and non-training areas of the time-series data 105 may be removed.

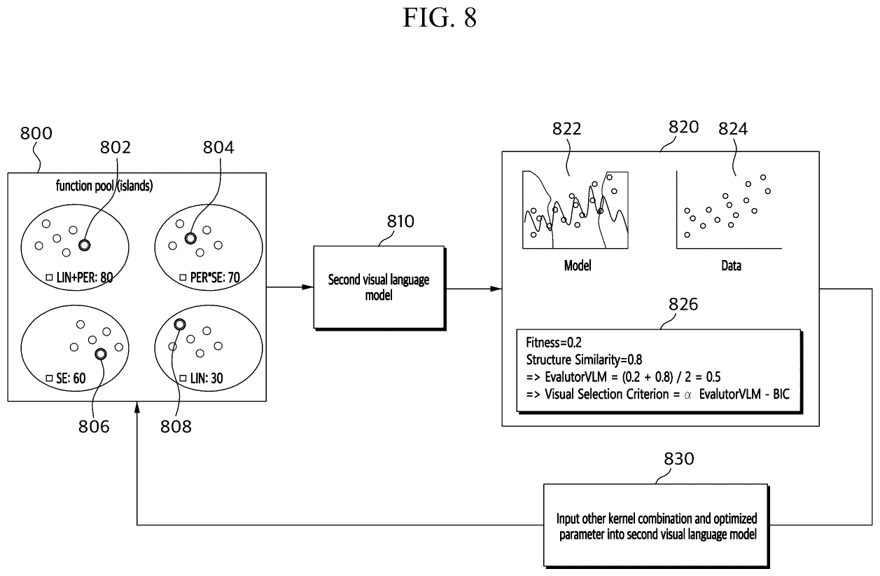

FIG. 8 is a diagram illustrating a process in which a second visual language model determines a score based on a kernel combination and an optimized parameter set, using the optimized parameter set for each kernel combination included in a pool of kernel combinations, according to one or more embodiments.

The electronic device 100 may determine optimized parameter sets 802,804, 806, and, 808, for example, for kernel combinations determined in the second process 120 for each kernel combination in a kernel combination pool 800, which includes at least one kernel combination generated by repeatedly executing the first process 110 through the fourth process 140, and input the optimized parameter sets into a second visual language model 810. The second visual language model 810 may determine output data by determining a score 826 based on time-series data 105, each kernel combination, and a first graph 824 and at least one second graph 822 relevant to the optimized parameter sets. Detailed descriptions on characteristics of input and output data of the second visual language model 810 will be omitted, as they have already been described above.

In response to determining the score for the current kernel combination, the second visual language model 810 may input another kernel combination along with its optimized parameter set into the second visual language model 810 and repeat the process 830 to determine a score of each kernel combination and optimized parameter set included in the kernel combination pool 800.

The electronic device 100 may remove a kernel combination from the kernel combination pool 800 that does not satisfy a predetermined condition related to an extrapolation test in a non-training interval, during which time-series data 105 is not present, by performing cross-validation on each kernel combination with a determined score. Accordingly, the electronic device 100 may divide the time-series data 105 into multiple subsets, and perform K-fold cross-validation that uses each subset alternately for training and validation. Through this, the electronic device 100 of one or more embodiments may prevent the first visual language model 114 and second visual language model 132 from overfitting to specific training data, and may obtain a reliable performance indicator by performing an extrapolation test on a portion of the time-series data and/or the non-training interval during which the time-series data 105 is not present. The electronic device 100 may perform cross-validation on each kernel combination and compare the kernel combinations using mean square error (MSE), mean absolute error (MAE), and coefficient of determination, for example. When an error of a kernel combination is greater than a predetermined criteria, the electronic device 100 may remove the kernel combination from the kernel combination pool 800.

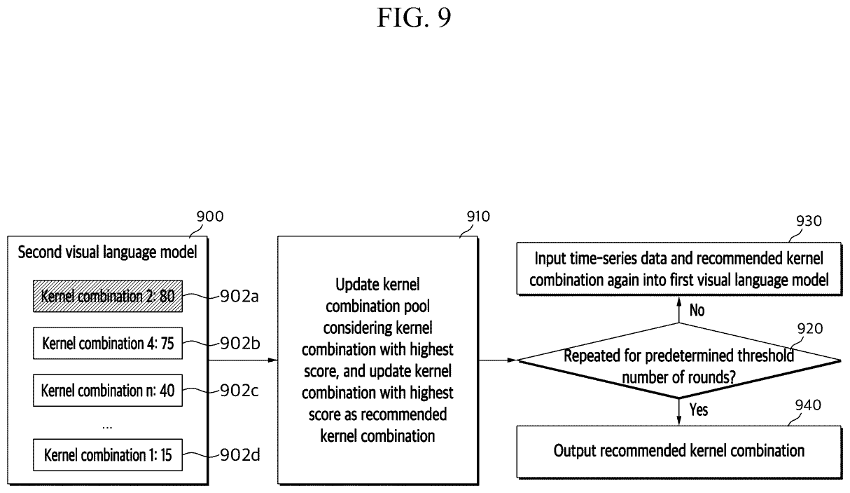

FIG. 9 is a diagram illustrating a process of outputting a recommended kernel combination among a plurality of kernel combinations, based on a score output by a second language model according to one or more embodiments.

The electronic device 100 may determine scores 902a, 902b, 902c, and 902d for each kernel combination included in a kernel combination pool by executing the fourth process 140 through a second visual language model 900, and manage the kernel combinations in descending order of scores. Based on the scores determined in the fourth process 140, the electronic device 100 may determine and store a kernel combination with highest score as a recommended kernel combination. As described above, the first to fourth processes 110 to 140 may be repeated for a threshold number of rounds. The at least one kernel combination determined in the first process 110 may be stored in the kernel combination pool, and the recommended kernel combination determined in the fourth process 140 may be used as input data for the first visual language model in the subsequent round of the first process 110.

The second visual language model 900 may determine a predetermined number of kernel combinations as recommended kernel combinations among the at least one kernel combination in descending order of scores. The predetermined number of kernel combinations may be one or more. The electronic device 100 may determine whether the number of repeated rounds of the first to fourth processes 110 to 140 corresponds to a predetermined threshold number of rounds in operation 920.

When the number of repeated rounds is less than the predetermined threshold number of rounds, the electronic device 100 may repeat the first process 110 by inputting the recommended kernel combination determined in the fourth process 140, along with the time-series data 105, to the first visual language model 114.

When the number of repeated rounds equals to the predetermined threshold number of rounds, the electronic device 100 may output the recommended kernel combination 902a determined in the fourth process 140, for example, as a kernel combination that aligns with the time-series data 105, along with information on the optimized parameter set in operation 940.

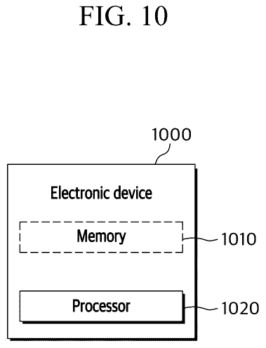

FIG. 10 is a block diagram illustrating an electronic device 1000 according to one or more embodiments. The electronic device 1000 of FIG. 10 may correspond to the electronic device 100 of FIG. 1.

Referring to FIG. 10, the electronic device 1000 may include a memory 1010 (e.g., one or more memories) and a processor 1020 (e.g., one or more processors), according to one or more embodiments. The memory 1010 may be included inside the electronic device 1000 but may also be placed outside the electronic device 1000. The processor 1020 may be implemented as a single processor or multi-processor. The electronic device 1000 may be a general-purpose processor, such as a central processing unit (CPU), an application processor (AP), and a digital processing unit (DSP), a processor for graphics, such as a graphic processing unit (GPU) and a vision processing unit (VPU), and/or a processor for neural network models, such as a neural processing unit (NPU).

It is to be understood by those skilled in the art that other general elements apart from the elements shown in FIG. 10, such as a display and an input interface, may also be included. Since the description above may be applied to the electronic device 1000, a redundant description will be omitted.

The processor 1020 may control overall operation of the electronic device 1000, and process data and a signal. That is, the processor 1020 may control overall operation of the electronic device 1000 using at least one instruction stored in the memory 1010 and process data and signals. For example, the memory 1010 may be or include a non-transitory computer-readable storage medium storing instructions that, when executed by the processor 1020, configure the processor 1020 to perform any one, any combination, or all of the operations and/or method disclosed herein with reference to FIGS. 1-11.

The processor 1020 may perform training and data input/output processes for the first visual language model 114 and second visual language model 132 used in the aforementioned example embodiments. The first visual language model 114 and second visual language model 132 of the processor 1020 may perform multi-modal learning while processing image and text data simultaneously.

The processor may input image and text data into the first visual language model 114 and second visual language model 132 to perform multi-modal learning and inference. The first visual language model 114 and second visual language model 132 may go under data preprocessing, multi-modal embedding, multi-modal determination and inference, and output post-processing, for data input and output.

The processor 1020 may pre-process image and text data individually during the process of inputting data into the first visual language model 114 and second visual language model 132, and convert them into a form that can be processed by the models. For example, the image data may be converted into a vector form through size adjustment, normalization, patch embedding, and/or feature extraction based on convolutional neural networks (CNN). The text data may be embedded into a high-dimensional vector through tokenization and vocabulary mapping.

During the multi-modal embedding process, processor 1020 may use the first visual language model 114 and second visual language model 132, which are trained to process the converted image and text vector in one integrated expression space. Image embedding converts an image feature to a high-dimensional vector using CNNs or vision transformers (ViTs) and text embedding vectorizes using a lookup table (embedding vector table) for each token. The two embeddings are then integrated either by simply concatenating them or training the connection between the image and text using cross-attention.

During the multi-modal determination and inference, the processor 1020 may use the first visual language model 114 and the second visual language model 132, which are trained to learn about semantic relationship between image and text inputs and extract information by performing transformer-based determination. During this process, information within individual modal may be learned through self-attention, and semantic connection between the image and text may be enhanced using cross-attention. Through this, the models may learn how a specific object in an image is associated with a specific word, and apply this knowledge to perform various tasks such as image-text matching, image captioning, and visual question answering (VQA).

During output post-processing, the processor 1020 may utilize the results generated by the first visual language model 114 and second visual language model 132 to fulfill the purposes described in the example embodiments of the present disclosure.

According to one or more embodiments, the electronic device 100 may determine a recommended kernel combination based on the example embodiments described herein, and, using the recommended kernel combination, may determine predictive data distribution in an interval during which time-series data is not present. The electronic device 100 may generate a visual output of at least one of the predictive data distribution and a summarized information of the predictive data distribution. According to another example embodiment, the electronic device 100 may transmit at least one of the predictive data distribution and the summarized information of the predictive data distribution to an external device for visual output through the external device. Time-series data may refer to data generated in various fields that exhibit time-series characteristics, and the electronic device 100 may determine an optimal kernel combination suitable for each data type as the recommended kernel combination, according to the example embodiments described herein. For example, in data related to semiconductor manufacturing, a long-term process change may be determined by analyzing process variables and performing anomaly detection, and forecasted data relevant to the time-series data may be determined by considering factors such as a recurring specific pattern and short-term variability. Accordingly, the electronic device 100 may support optimization of the semiconductor manufacturing process and enable early-stage anomaly detection. In addition, financial, economic, weather, environmental, and medical data, and the like may be utilized as time-series data in the example embodiments described herein.

The electronic device 100 may generate a visual output of forecasted data and a summary thereof, either directly or through an external device, and may provide, in a summarized format, characteristics of the forecasted data that may be relevant to the field from which the time-series data originates, to a user or manager. For example, semiconductor manufacturers may receive a summary indicating whether process optimization is required, predicted defect rates, and detected equipment errors, financial data analysis may provide a summary of estimated trends in stock prices and exchange rates, along with estimates of sudden volatility, weather data analysis may offer a summary of estimated trends, such as temperature and air pollution levels, including sudden changes, and in the medical field, a summary of estimated trends related to a patient's health monitoring and electrocardiogram (ECG) patterns, along with the likelihood of sudden deterioration or mortality, may be provided.

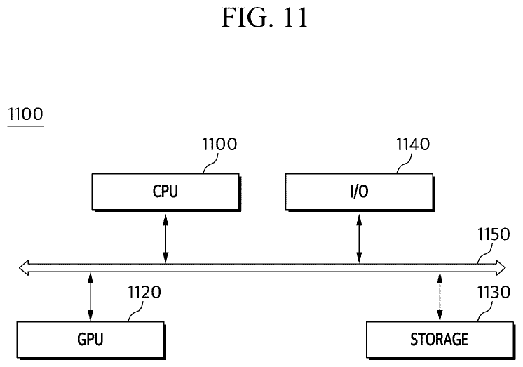

FIG. 11 is a block diagram illustrating a computing system including the electronic device 100. It is to be understood by those skilled in the art that a computing system 1100 may also include general-purpose elements other than the elements shown in FIG. 11. The computing system 1100 may correspond to the electronic device that performs the data processing method described herein. The above-described content may be applied to the electronic device 100 included in the computing system 1100, and a redundant description is incorporated herein by reference to the foregoing description. For example, the processor 1020 of FIG. 10 may be or include a central processing unit (CPU) 1110 and a graphic processing unit (GPU) 1120 of FIG. 11, and the memory 1010 of FIG. 10 may be or include a storage 1130 of FIG. 11.

Referring to FIG. 11, the computing system 1100 may include a central processing unit (CPU) 1110, a graphic processing unit (GPU) 1120, a storage 1130, an input/output (I/O) device 1140, and a data bus 1150.

The CPU 1110 may execute software (e.g., an application program or an operating system) to be run by the computing system 1100 and process data. The GPU 1120 may process various graphics or perform parallel processing. That is, the GPU 1120 may repeat similar processes to have a structure suitable for parallel processing. Accordingly, the GPU 1120 may be used for various processes requiring high-speed parallel processing, in addition to graphics processing. The GPU 1120 may process operations used by the first visual language model 114 and second visual language model 132.

The storage 1130 may correspond to a storage medium included in the electronic device 100. The storage 1130 may store various types of information that are generated and managed by the first visual language model 114 and second visual language model 132, application programs, and described example embodiments. For example, various types of information, such as at least one kernel combination determined by the first visual language model 114, a recommended kernel combination determined by the second visual language model 132, a kernel combination pool and parameter sets the electronic device 100 manages during the first to fourth processes 110 to 140, may be stored in the storage 1130.

The storage 1130 may be provided as a memory card, such as a multi-media card (MMC), an embedded multi-media card (eMMD), and a microSD, and/or as a hard-disk drive (HDD). The storage 1130 may include a NAND-type flash memory that has a large storage capacity. Alternatively, the storage 1130 may receive and transmit data to and from the CPU 1110 and GPU 1120 and store data and/or an instruction required for executing a program. Here, the storage 1130 may be a volatile memory device, such as dynamic random-access memory (DRAM), synchronous dynamic random-access memory (SDRAM), double data rate (DDR), low power double data rate (LPDDR), graphics double data rate (GDDR), Rambus dynamic random-access memory (RDRAM), and static random-access memory (SRAM). Alternatively, the storage may be implemented in a volatile memory device, such as resistive random-access memory (RRAM), phase-change memory (PRAM), magnetoresistive random-access memory (MRAM), ferroelectric random-access memory (FRAM), and spin transfer torque random-access memory (STT-RAM).

The I/O device 1140 may include at least one input device configured to receive data, such as a mouse or a keyboard, and at least one output device configured to output data, such as a monitor, speaker and printer.

The CPU 1110, GPU 1120, storage 1130, and I/O device 1140 may be combined with each other through the data bus 1150. The data bus 1150 may correspond to a path in which data is transferred. The configuration of data bus 1150 is not limited to the above description and may also include arbitration mechanisms for effective management.

According to example embodiments, the computing system 1100 may include a laptop computer, a desktop, a notebook computer, a smartphone, a tablet PC, an MP3 player, a personal digital assistant (PDA), a portable multimedia player (PMP), a digital TV, a digital camera, a portable game console, a navigation device, a wearable device, a virtual reality (VR) device, a drone, and/or various kinds of servers processing time-series data 105.

The electronic devices, memories, processors, computing systems, CPUs, GPUS, storages, I/O devices, data buses, electronic device 100, electronic device 1000, memory 1010, processor 1020, computing system 1100, CPU 1110, GPU 1120, storage 1130, I/O device 1140, and data bus 1150 described herein, including descriptions with respect to respect to FIGS. 1-11, are implemented by or representative of hardware components. As described above, or in addition to the descriptions above, examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit (ALU), a digital signal processor (DSP), a microcomputer, a programmable logic controller, a field-programmable gate array (FPGA), a programmable logic array (PLU), a microprocessor, or any other device or combination of devices that is configured to respond to and execute instructions (e.g., code or coding) in a defined manner to achieve a desired result. In one example, a processor or computer includes, or is connected to, one or more memories storing the instructions or software that are executed by the processor or computer. Hardware components implemented by a processor or computer may execute the instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both, and thus while some references may be made to a singular processor or computer, such references also are intended to refer to multiple processors or computers. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. As described above, or in addition to the descriptions above, example hardware components may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing. Thus, references to a processor herein mean processing circuitry (e.g., circuitry that includes one or more processing element(s) circuits). One or more processors comprising processing circuitry also refers to each processor comprising processing circuitry, as well as some or all of the one or more processors comprising the same processing circuitry. In addition, processors(s) and controller(s), as a non-limiting example, do not mean human processing or human control, but rather, refer to hardware components as described herein, as non-limiting examples.

The methods illustrated in, and discussed with respect to, FIGS. 1-11 that perform the operations described in this application are performed by computing hardware, for example, by one or more processors or computers, implemented as described above implementing the instructions (e.g., computer or processor/processing device readable instructions) or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations. References to a processor, or one or more processors, as a non-limiting example, configured to perform two or more operations refers to a processor or two or more processors being configured to collectively perform all of the two or more operations, as well as a configuration with the two or more processors respectively performing any corresponding one of the two or more operations (e.g., with a respective one or more processors being configured to perform each of the two or more operations, or any respective combination of one or more processors being configured to perform any respective combination of the two or more operations). Likewise, a reference to a processor-implemented method is a reference to a method that is performed by one or more processors or other processing or computing hardware of a device or system.

The instructions or software to control computing hardware, for example, one or more processors or computers, to implement the hardware components and perform the methods as described above may be written as computer programs, code segments, or other executable instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media, and thus, not a signal per se. Thus, references herein to storage media mean storage media hardware, and does not mean transitory media, nor a signal per se. As described above, or in addition to the descriptions above, examples of a non-transitory computer-readable storage medium include one or more of any of read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as a multimedia card or a micro card (for example, secure digital (SD) or extreme digital (XD)), magnetic tapes, floppy disks, magneto-optical data storage devices, optical data storage devices, hard disks, solid-state disks, and/or any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure/

What is claimed is:

1. A processor-implemented method comprising:
determining one or more kernel combinations corresponding to time-series data based on information output by inputting the time-series data, information on a predetermined kernel combination, and first prompt information into a first visual language model (VLM);
determining an optimized parameter set from one or more parameter sets, for each of the one or more kernel combinations;
inputting second prompt information into a second VLM to analyze one or more graphs corresponding to the optimized parameter set, for each of the one or more kernel combinations;
determining one or more scores for each of the one or more kernel combinations based on an output generated by the inputting of the second prompt information into the second VLM; and
determining, in response to the one or more scores being determined, a recommended kernel combination from the one or more kernel combinations based on the one or more scores.

2. The processor-implemented method of claim 1, wherein the determining of the one or more kernel combinations comprises:
determining whether analytical information output by the first VLM, based on the time-series data, the information on the predetermined kernel combination, and the first prompt information, is included in a model space in which the first VLM is able to learn about the predetermined kernel combination based on the time-series data; and
determining the one or more kernel combinations based on the analytical information in response to the analytical information being determined to be included in the model space.

3. The processor-implemented method of claim 2, wherein the determining of whether the analytical information is included in the model space comprises:
determining first context information based on the time-series data, the information on the predetermined kernel combination, and the first prompt information; and
based on the analytical information output by inputting the first context information into the first VLM, performing a process comprising:
updating, in response to the analytical information being included in a language space, the first context information based on the analytical information;
updating, in response to the analytical information being included in a code space, the first context information based on observation information which is obtained by executing code generated based on the analytical information; and
determining, in response to the analytical information being included in the model space, the one or more kernel combinations based on the analytical information.

4. The processor-implemented method of claim 3, wherein the performing of the process comprises:
determining whether a length of second context information, generated by updating the first context information, is less than a predetermined maximum context length; and
repeating the process based on the second context information, in response to the length of the second context being less than the predetermined maximum context length.

5. The processor-implemented method of claim 1, further comprising:
determining a plurality of initial parameter sets for each of the one or more kernel combinations using a genetic algorithm,
wherein determining the optimized parameter set includes determining the optimized parameter set through likelihood-based optimization of the plurality of initial parameter sets.

6. The processor-implemented method of claim 1, wherein the one or more graphs include:
a first graph plotted based on the time-series data; and
one or more second graphs plotted based on the one or more kernel combinations and the optimized parameter set.

7. The processor-implemented method of claim 6, wherein the determining of the one or more scores comprises determining a difference between a value obtained by multiplying information output by the second VLM by a weight, and a Bayesian information criterion (BIC) for the one or more kernel combinations and the time-series data, as the one or more scores.

8. The processor-implemented method of claim 6, wherein the second prompt information includes an instruction to evaluate similarity between the first graph and each of the one or more second graphs in a first interval containing the time-series data, and structure similarity of the one or more second graphs between the first interval and a second interval during which the time-series data is not present.

9. The processor-implemented method of claim 6, further comprising removing a kernel combination from the one or more kernel combinations through cross-validation, that does not satisfy a predetermined condition related to an extrapolation test in an interval during which the time-series data is not present.

10. The processor-implemented method of claim 1, wherein the determining of the optimized parameter set further comprises removing one or more parameter sets from the one or more parameter sets for each of the one or more kernel combinations.

11. The processor-implemented method of claim 1, wherein the determining of the recommended kernel combination comprises determining a predetermined number of kernel combinations from the one or more kernel combinations as the recommended kernel combination, based on descending order of the one or more scores.

12. The processor-implemented method of claim 1, further comprising:
determining a predictive data distribution in an interval during which the time-series data is not present, based on the determined recommended kernel combination; and
visually outputting either one or both of the predictive data distribution and summarized information of the predictive data distribution.

13. An electronic device comprising:
one or more processors comprising processing circuitry; and
memory comprising one or more storage media storing instructions that, when executed individually or collectively by the one or more processors, cause the electronic device to:
determine one or more kernel combinations corresponding to time-series data based on information output by inputting the time-series data, information on a predetermined kernel combination, and first prompt information into a first visual language model (VLM);
determine an optimized parameter set from one or more parameter sets, for each of the one or more kernel combinations;
input one or more graphs corresponding to the optimized parameter set into a second VLM, for each of the one or more kernel combinations;
determine one or more scores for each of the one or more kernel combinations based on an output generated by the inputting of the one or more graphs into the second VLM; and
determine, in response to the one or more scores being determined, a recommended kernel combination from the one or more kernel combinations based on the one or more scores, by executing the instruction.

14. The electronic device of claim 13, wherein, for the determining of the one or more kernel combinations, the execution of the instructions causes the electronic device to:
determine whether analytical information output by the first VLM, based on the time-series data, the information on the predetermined kernel combination, and the first prompt information, is included in a model space in which the first VLM is able to learn about the predetermined kernel combination based on the time-series data; and
determine the one or more kernel combinations based on the analytical information in response to the analytical information being determined to be included in the model space.

15. The electronic device of claim 14, wherein, for the determining of whether the analytical information is included in the model space, the execution of the instructions causes the electronic device to:
determine first context information based on the time-series data, the information on the predetermined kernel combination, and the first prompt information and
based on the analytical information output by inputting the first context information into the first VLM, perform a process comprising:
updating, in response to the analytical information being included in a language space, the first context information based on the analytical information;
updating, in response to the analytical information being included in a code space, the first context information based on observation information which is obtained by executing code generated based on the analytical information; and
determining, in response to the analytical information being included in the model space, the one or more kernel combinations based on the analytical information

16. The electronic device of claim 15, wherein, for the performing of the process, the execution of the instructions causes the electronic device to:
determine whether a length of second context information, generated by updating the first context information, is less than a predetermined maximum context length; and
repeat the process based on the second context information, in response to the length of the second context being less than the predetermined maximum context length.

17. The electronic device of claim 13, wherein the one or more graphs include:
a first graph plotted based on the time-series data; and
one or more second graph plotted based on the one or more kernels combination and the optimized parameter set.

18. The electronic device of claim 17, wherein, for the determining of the one or more scores, the execution of the instructions causes the electronic device to determine a difference between a value obtained by multiplying information output by the second VLM by a weight, and a Bayesian information criterion (BIC) for the one or more kernel combinations and the time-series data, as the one or more scores.

19. The electronic device of claim 17, wherein the second prompt information includes an instruction to evaluate similarity between the first graph and each of the one or more second graphs in a first interval containing time-series data, and structural similarity of the one or more second graphs between the first interval and a second interval during which the time-series data is not present.

20. A processor-implemented method comprising:
determining context information based on time-series data, information on a predetermined kernel combination, and first prompt information;
determining analytical information by inputting the context information to a first visual language model (VLM), in response to a length of the context information being less than a predetermined maximum context length;
updating the context information based on either one or both of the analytical information and observation information, depending on whether the analytical information is included in a language space or a code space; and
determining one or more kernel combinations corresponding to the time-series data based on the updated the context information.
